(19) United States
(12) Patent Application Publication
(10) Pub. No.: US 2008/0018624 A1
(43) Pub. Date: Jan. 24, 2008

(54) Display for displaying compressed video based on sub-division area

(75) Inventor: Andrei Cernasov, Ringwood, NJ (US)

Correspondence Address: Honeywell International, Inc.;Law Department AB2, P.O. Box 2245, Morristown, NJ, 07962-2245, US

(73) Assignee: Honeywell International, Inc.

(21) Appl. No.: 11/482,045

(22) Filed: Jul. 7, 2006

(51) Int. Cl. G09G 5/00

(52) U.S. Cl. 345/204

(57) ABSTRACT

A display is configured to display transformed video. The display includes a display unit comprising pixels. Each pixel is divided into sub-divisions and each sub-division has a gain that is related to coefficients or partial coefficients in a transformation algorithm.

### FIELD

This disclosure generally relates to displays. More particularly, the subject matter of this disclosure pertains to displays that are capable of displaying compressed video.

### BACKGROUND

Conventional displays receive video signals which represent either still or moving images. Conventional displays require that the video signals be uncompressed in order to properly display the video.

Typically, video is stored or transmitted in compressed format such as Joint Photographic Experts Group (JPEG) format for still images and Moving Pictures Experts Group (MPEG) for moving images. For example, in JPEG compression, the image is down sampled from the original 12- or 14-bit data back to 8 bits before performing the JPEG compression. Then, a large set of calculations must be performed on the image data to compress the image. Accordingly, any compressed video signal must be decompressed before a conventional display may display the video. Thus, a separate processor or a processor in the display must decompress the video signal before the video may be displayed.

Indeed, some digital devices that include a display, such as a digital camera or cell phone, may include a separate digital signal processor or other form of processor in order to perform decompression, such as JPEG decompression. Therefore, support of the decompression algorithm can consume a large amount of time and power in such digital devices.

It may be desirable to reduce the amount processing and power required for digital devices. Due to their popular acceptance, compressed video can be generated and handled by a wide variety of devices. For example, devices like video cameras, mobile phones, personal digital assistants (PDAs), digital media players such as I-Pods etc., are now capable of displaying compressed video, such as JPEG images or MPEG images. However, these devices must also conserve space used by the components and the amount of power they consume (since they run on batteries). It may also be desirable to speed the processing related to decompression, such as, for security applications.

Accordingly, it would be desirable to systems and methods that efficiently implement decompression algorithms to display compressed video, such as a JPEG, image without the extra processing and hardware involved.

### SUMMARY

Embodiments of the present teaching are directed to a display configured to display transformed video. The display comprises a display unit comprising pixels. Each pixel is divided into sub-divisions and each sub-division has a gain that is related to coefficients or partial in a transformation algorithm.

Embodiments also are directed to a display configured to display transformed video. The display comprises a display unit comprising video divisions groped into blocks. Each video division is divided into sub-divisions and each sub-division has a gain that is related to coefficients or partial coefficients in a transformation algorithm.

Embodiments are also directed to a device comprising a video source capable of providing a compressed video signal representing transformation values of a compression method. The device also comprises a display configured to display the compressed video signal based on the transformation values. The display comprises a display unit comprising pixels. Each pixel is divided into sub-divisions and each sub-division has an area that is related to coefficients in a transformation algorithm.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments of the invention and together with the description, serve to explain the principles of the invention.

FIG. 1 is a block diagram illustrating an exemplary display consistent with embodiments of the present teaching.

FIGS. 2-5 are diagrams illustrating an exemplary filter consistent with embodiments of the present teaching.

FIG. 6 is a diagram illustrating an exemplary driving circuit consistent with embodiments of the present teaching.

FIG. 7 is a diagram illustrating an exemplary portion of a display unit consistent with the present teaching.

### DETAILED DESCRIPTION

As noted above, in conventional displays, video, which includes still and moving images, is usually imputed to or stored in the displays in a compressed format, such as JPEG or MPEG. The display device uses “back-end” processing to decompress the video into a format that may be displayed by the display. Unfortunately, this type of “back-end” processing often requires the use of a separate digital signal processor or a separate computing device to perform the calculations necessary for the decompression algorithm. As such, conventional devices consume a large amount of power, take long times to decompress the video, and increase in size to accommodate additional hardware.

However, embodiments of the present teaching provide a display that implements “front-end” processing to perform part of a decompression or transformation algorithm when displaying video. In particular, the display uses transformation values of the compression or transformation algorithm directly as the video signal. The display includes a display unit which converts the video signal composed of transformation values into the actual viewable video.

For example, a display unit may be composed of video divisions, such as pixels. Each division is subdivided into sub-divisions, such as sub-pixels. Each sub-division of display device receives a video signal corresponding to transformation coefficients of compressed video. The transformation coefficients may be complete coefficients or partial coefficients. The number of sub-divisions corresponds to the number of transformation coefficients or partial coefficients used by the compression algorithm.

Each sub-division of the display unit has a gain related to the transformation coefficient or partial coefficient of the compression or transformation algorithm. As such, the sub-divisions with gain transform the video signal received by the display into an actual viewable video signal. Accordingly, the display device produces video without having to decompress or transform the compressed or transformed video signal.

In addition, in order to simplify the display device, a reduced or compressed number of transformation coefficients or partial coefficients (such as 20) may be used. Also, sub-divisions across different divisions, but corresponding to the same transformation coefficient or partial coefficient may be connected in parallel.

Additionally, according to additional embodiment of the present teaching gain in the sub-divisions may be achieved by varying the area of sub-divisions in the display unit of the display. Accordingly, the display device produces video without having to decompress or transform the compressed or transformed video signal.

By using “front-end” processing, embodiments of the present teaching can be implemented using less power, less memory, and reduced physical size. In addition, such “front-end” processing may significantly reduce or even eliminate delays in displaying video and power consumption of a display. Thus, for example, the performance of small size, battery powered, camera systems such as cell phones, web cameras, digital cameras, and surveillance systems may be enhanced.

Reference will now be made in detail to the present exemplary embodiments of the invention, examples of which are illustrated in the accompanying drawings. Wherever possible, the same reference numbers will be used throughout the drawings to refer to the same or like parts.

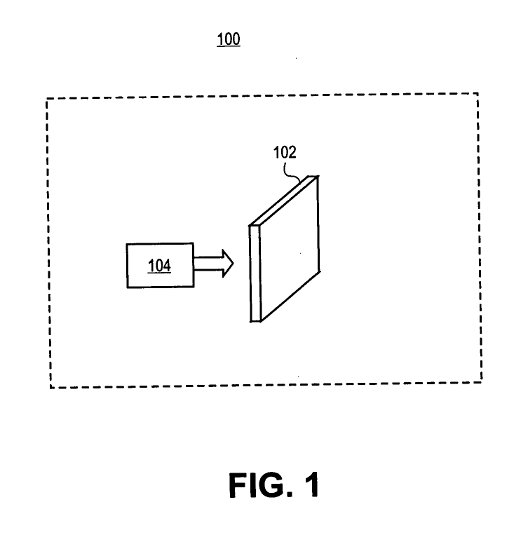

FIG. 1 is a block diagram illustrating an exemplary display 100 consistent with embodiments of the present teaching. Display 100 may be any type of display capable of displaying video, such as a still image or moving image, based on a video signal. For example, display 100 may be a liquid crystal display (LCD). It should be readily apparent to those of ordinary skill in the art that display 100 illustrated in FIG. 1 represents a generalized schematic illustration and that other components may be added or existing components may be removed or modified.

Display 100 may be a stand alone display that receives video signals from an external device. For example, display 100 may be a monitor coupled to a computing device. Further, display 100 may be incorporated in a device that stores, receives, or captures compressed data. For example, display 100 may be a video screen in a cell phone or digital camera. One skilled in the art will realize that display 100 may be utilized with any type of device capable of producing, outputting, transmitting, or receiving video such as still images or moving images.

As illustrated in FIG. 1, display 100 includes a display unit 102 and a display control 104. For example, if display 100 is an LCD, display unit 102 may include a light source such as a light emitting diode (LED) backlight. Further, if display 100 is an LCD, display unit 102 may include a liquid crystal panel that comprises video divisions such as pixels positioned in front of the light source. One skilled in the art will realize that display unit 102 may include any additional hardware, software, firmware, or combination thereof to produce video based on a video signal.

As illustrated in FIG. 1, display 100 also includes display control 104. Display control 104 may include any hardware, software, firmware or combination thereof to control display unit 102 and to provide a compressed video signal to display unit 102. One skilled in the art will realize that display unit 104 may include any additional hardware, software, firmware, or combination thereof to control display unit 102 and provide a compressed video signal to display unit 102.

Display unit 102 may perform “front-end” processing on the video signal received from display control 104. The video signal received may be a compressed video signal composed of transformation values of a compression or transformation algorithm. Display unit 102 may perform part of a decompression or inverse transformation algorithm on a compressed or transformed video signal being displayed by display 100. For example, the compression algorithm may be JPEG or MPEG.

Display unit 102 may be composed of multiple video divisions. For example, display unit 102 may be composed of multiple video divisions that represent the divisions in a video signal, such as pixels. To display compressed or transformed video, display unit 102 receives a signal based on the transformations values of the compression or transformation algorithm. Display unit 102 may perform “front-end” processing on the received a video signal which represents transformation values. Particularly, display unit 102 may perform a part of the decompression or inverse transformation algorithm on the video signal, representing the inverse transformation values, to produce actual viewable video.

As mentioned above, display 102 may be composed of multiple video divisions. Video division of display unit 102 may also be further sub-divided. In such a case, each sub-division of display unit 102 receives a signal corresponding to a compressed or transformed video signal. Each sub-division of video divisions in display unit 102 generates video by receiving a specific transformation value of the compression or transformation algorithm corresponding to the sub-division position.

Each sub-division of display unit 102 may be related to the respective transformation value of the corresponding portion of video signal. As such, each sub-division of display unit 102 may be driven with the corresponding transformation value. Display unit 102 may inverse transform the signal received by the corresponding sub-division of display unit 102 into actual video.

Particularly, each sub-division of the video division in display unit 102 may have a gain related to the decompression or inverse transformation algorithm. As such, the video signal, representing transformation values and driving each sub-division, may be changed into the actual viewable video signal. By this process, display 100 produces video without having to perform additional processing on the compressed or transformed video signal.

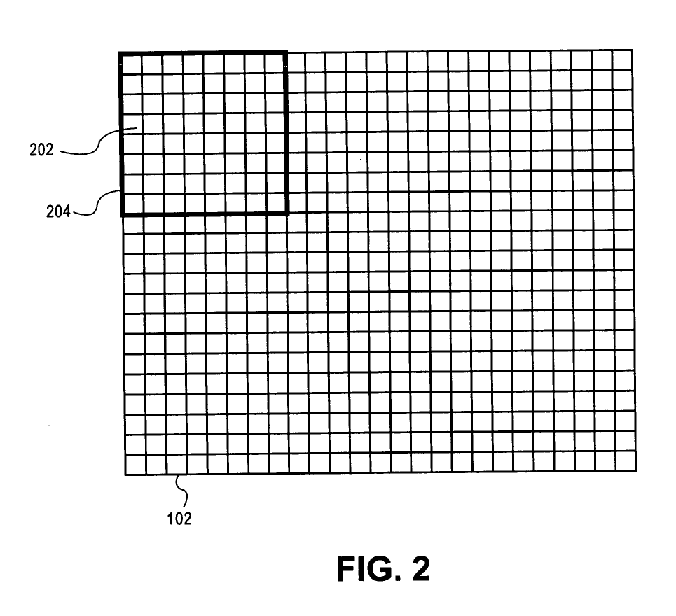

FIGS. 2-4, 5A, and 5B illustrate an exemplary display unit 102 which may be used in display 100. Display unit 102 may be configured to be used with transform encoding for video such as the JPEG compression algorithm for a still image or MPEG compression algorithm for moving images. Display unit 102 alters a video signal corresponding to the transformation coefficients or partial coefficients of the JPEG or other transformation algorithm such that the video signal received by display panel 102 is converted to actual viewable video. It should be readily apparent to those of ordinary skill in the art that display unit 102 illustrated in FIGS. 2-5 represents generalized schematic illustrations and that other components may be added or existing components may be removed or modified.

The JPEG algorithm is designed to compress either color or grey-scale digital images. Conceptually, JPEG compresses a digital image based on a mathematical tool known as the DCT and empirical adjustments to account for the characteristics of human vision.

The basic DCT can be expressed by the formula:

$$D ( i , j ) = \frac{2}{\sqrt{MN}} C ( i ) C ( j ) {\sum }_{m = 0}^{m = M - 1} {\sum }_{n = 0}^{n = N - 1} p ( m , n ) cos [ \frac{( 2 m + 1 ) i π}{2 M} ] cos [ \frac{( 2 n + 1 ) j π}{2 N} ]$$

where C(i) and C(j) coefficients are:

C(k)=1/\sqrt{2}(for k=0), or =1 (for k>0); and

where p(m,n) represents the pixel values, either intensity or color.

JPEG applies the DCT to an elementary image area (called an “image block”) that are 8 pixels wide and 8 lines high. This causes the basic DCT expression to simplify to:

$$D ( i , j ) = \frac{1}{4} C ( i ) C ( j ) {\sum }_{m = 0}^{m = 7} {\sum }_{n = 0}^{n = 7} p ( m , n ) cos [ \frac{( 2 m + 1 ) i π}{16} ] cos [ \frac{( 2 n + 1 ) j π}{16} ]$$

Therefore, in essence, JPEG uses the DCT to calculate the amplitude of spatial sinusoids that, when superimposed, can be used to recreate the original image.

In order to compress the data for an image, JPEG also combines a set of empirical adjustments to the DCT. The empirical adjustments have been developed through experimentation and may be expressed as a matrix of parameters that synthesizes or models what a human vision actually sees and what it discards. Through research, it was determined that a loss of some visual information in some frequency ranges is more acceptable than others. In general, human eyes are more sensitive to low spatial frequencies than to high spatial frequencies. As a result, a family of quantization matrices Q was developed. In a Q matrix, the bigger an element, the less sensitive the human eye is to that combination of horizontal and vertical spatial frequencies. In JPEG, quantization matrices are used to reduce the weight of the spatial frequency components of the DCT processed data, i.e., to model human eye behavior. The quantization matrix Q₅₀ represents the best known compromise between image quality and compression ratio and is presented below.

$${Q}_{50} = [ \begin{matrix}16 & 11 & 10 & 16 & 24 & 40 & 51 & 61 \\ 12 & 12 & 14 & 19 & 26 & 58 & 60 & 55 \\ 14 & 13 & 16 & 24 & 40 & 57 & 69 & 56 \\ 14 & 17 & 22 & 29 & 51 & 87 & 80 & 62 \\ 18 & 22 & 37 & 56 & 68 & 109 & 103 & 77 \\ 24 & 35 & 55 & 64 & 81 & 104 & 113 & 92 \\ 49 & 64 & 78 & 87 & 103 & 121 & 120 & 101 \\ 72 & 92 & 95 & 98 & 112 & 100 & 103 & 99\end{matrix} ]$$

For higher compression ratios, poorer image quality, the Q₅₀ matrix can be multiplied by a scalar larger than 1 and clip all results to a maximum value of 255. For better quality images, but less compression, the Q₅₀ matrix can be multiplied by a scalar less than 1.

Therefore, the JPEG algorithm can be expressed as the following equation:

$$K ( i , j ) = \frac{1}{4} \frac{C ( i ) C ( j )}{Q ( i , j )} {\sum }_{m = 0}^{m = 7} {\sum }_{n = 0}^{n = 7} p ( m , n ) cos [ \frac{( 2 m + 1 ) i π}{16} ] cos [ \frac{( 2 n + 1 ) j π}{16} ]$$

Of note, the application of the quantization matrix with the DCT essentially eliminates many of the frequency components of the DCT alone. The example below illustrates this phenomenon.

For clarity of presentation, the example is limited to a single 8×8 image block from a stock image. For example, suppose the image array I for a single image block is:

$$I = [ \begin{matrix}170 & 153 & 153 & 153 & 160 & 160 & 153 & 134 \\ 170 & 153 & 153 & 160 & 160 & 160 & 153 & 134 \\ 170 & 110 & 153 & 160 & 160 & 153 & 153 & 134 \\ 160 & 110 & 134 & 165 & 165 & 153 & 134 & 110 \\ 160 & 134 & 134 & 165 & 160 & 134 & 134 & 110 \\ 165 & 134 & 134 & 160 & 223 & 134 & 110 & 134 \\ 165 & 134 & 160 & 196 & 223 & 223 & 110 & 134 \\ 165 & 160 & 196 & 223 & 223 & 254 & 198 & 160\end{matrix} ]$$

Initially, it is noted that all values in the I matrix are positive. Therefore, before continuing, the apparent DC bias in the image can be removed by subtracting a value, such as 128, from the matrix I. A new matrix I′ results and is provided below.

$${I}^{′} = [ \begin{matrix}42 & 25 & 25 & 25 & 32 & 32 & 25 & 6 \\ 42 & 25 & 25 & 32 & 32 & 32 & 25 & 6 \\ 42 & - 18 & 25 & 32 & 32 & 25 & 25 & 6 \\ 32 & - 18 & 6 & 37 & 37 & 25 & 6 & - 18 \\ 32 & 6 & 6 & 37 & 32 & 6 & 6 & - 18 \\ 37 & 6 & 6 & 32 & 95 & 6 & - 18 & 6 \\ 37 & 6 & 32 & 68 & 95 & 95 & - 18 & 6 \\ 37 & 32 & 68 & 95 & 95 & 126 & 70 & 32\end{matrix} ]$$

From matrix algebra, the application of the DCT to the image array I is equivalent to multiplying the DCT matrix T by the matrix I. The result may then be multiplied with the transpose of T. From the DCT definition, the elements of the T matrix can be calculated by the equation:

$$T ( i , j ) = \sqrt{\frac{2}{M}} C ( i ) cos [ \frac{( 2 j + 1 ) i π}{2 M} ]$$

where i and j are row and column numbers from 0 to 7. For convenience, the T matrix is presented below.

$$T = [ \begin{matrix}0.3536 & 0.3536 & 0.3536 & 0.3536 & 0.3536 & 0.3536 & 0.3536 & 0.3536 \\ 0.4904 & 0.4157 & 0.2728 & 0.0975 & - 0.0975 & - 0.2778 & - 0.4157 & - 0.4904 \\ 0.4619 & 0.1913 & - 0.1913 & - 0.4619 & - 0.4619 & - 0.1913 & 0.1913 & 0.4619 \\ 0.4157 & - 0.0975 & - 0.4904 & - 0.2778 & 0.2778 & 0.4904 & 0.0975 & - 0.4157 \\ 0.3536 & - 0.3536 & - 0.3536 & 0.3536 & 0.3536 & - 0.3536 & - 0.3536 & 0.3536 \\ 0.2778 & - 0.4904 & 0.0975 & 0.4157 & - 0.4157 & - 0.0975 & 0.4904 & - 0.2778 \\ 0.1913 & - 0.4619 & 0.4619 & - 0.1913 & - 0.1913 & 0.4619 & - 0.4619 & 0.1913 \\ 0.0975 & - 0.2778 & 0.4157 & - 0.4904 & 0.4904 & - 0.4157 & 0.2778 & - 0.0975\end{matrix} ]$$

Continuing now with JPEG, the DCT may be applied to the image matrix I′ by multiplying it with T on the left and the transpose of T on the right. Rounding the result, the following matrix I″ is obtained.

$${I}^{″} = [ \begin{matrix}233 & 21 & - 103 & 78 & 51 & 18 & 25 & 8 \\ - 75 & 19 & 71 & - 21 & - 18 & 26 & - 18 & 12 \\ 104 & - 22 & - 14 & 5 & - 36 & - 11 & 16 & - 18 \\ - 47 & 31 & 10 & - 2 & 27 & - 38 & - 19 & 11 \\ 13 & - 7 & 3 & - 3 & - 29 & 25 & - 12 & - 10 \\ - 16 & - 1 & - 19 & 16 & 16 & - 8 & 25 & - 4 \\ 5 & - 10 & 11 & - 9 & 10 & 2 & - 9 & 24 \\ - 2 & 1 & 3 & - 3 & - 9 & 12 & 9 & - 9\end{matrix} ]$$

In order to consider the empirical data of human vision, each element of the I″ matrix is divided by the corresponding element of a quantization matrix and each result is rounded. For example, if quantization matrix Q₅₀ is used, the result I″ Q₅₀ is expressed below.

$${I}^{″} {Q}_{50} = [ \begin{matrix}15 & 2 & - 10 & 5 & 2 & 0 & 0 & 0 \\ - 6 & 2 & 5 & - 1 & - 1 & 0 & 0 & 0 \\ 7 & - 2 & - 1 & 0 & - 1 & 0 & 0 & 0 \\ - 3 & 2 & 0 & 0 & 1 & 0 & 0 & 0 \\ 1 & 0 & 0 & 0 & 0 & 0 & 0 & 0 \\ - 1 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0\end{matrix} ]$$

Of note, most of the elements in the result matrix round off to 0. In particular, only 19 of the 64 transformation coefficients are non-zero values. That is, JPEG has eliminated those components that were too small to overcome the human eye's lack of sensitivity to their spatial frequency.

If the quality level is dropped by using a quantization matrix, such as Q₁₀, approximately only 7 nonzero coefficients remain. Likewise, if the quality level is increased by using a quantization matrix, such as Q₉₀, approximately 45 coefficients remain. Therefore, for the most part, the JPEG algorithm utilizes relatively few of the 64 possible transformation coefficients of the DCT.

The number of terms that may bring a non-negligible contribution to the value of K(i,j) depends of the desired fidelity of the image. For example, only 10 to 30 of these 64 terms may bring a non-negligible contribution to the value of K(i,j), with 20 being the most common number. The JPEG algorithm obtains compression replacing the measurement and transmission of 64 pixel values (for each 8×8 tile) with the calculation and transmission of K(i,j) coefficient values. For example, if only 20 of these 64 terms bring a non-negligible contribution to the value of K(i,j), only these 20 coefficient values may be used to represent the image.

As discussed above, at the core of the JPEG algorithm is the division of the DCT coefficients of 8×8 tiles of the image of interest by the experimentally determined quantization values Q(i,j). To recover the actual image, the inverse Direct Cosine Transformation is applied to the K(i,j) coefficients.

The actual given value for a viewable pixel m,n would be given by:

$$p ( m , n ) = \frac{1}{4} {\sum }_{i = 0}^{i = 7} {\sum }_{i = 0}^{i = 7} C ( i ) C ( j ) Q ( i , j ) K ( i , j ) cos \frac{( 2 m + 1 ) i π}{16} cos \frac{( 2 n + 1 ) j π}{16}$$

Where:

p(m,n) is the pixel illumination for the image at the position m,n (within the 8×8 tile), Q(i,j) measures the eye sensitivity at the spatial frequencies i and j, and C(k) is given by:

$$C ( k ) = \{ \begin{matrix}\frac{1}{\sqrt{2}} & for k = 0 \\ 1 & for k > 0\end{matrix}$$

Returning to FIG. 2, display 100 by use of display unit 102 produces actual video by using a video signal composed of K(i,j) values. Display unit 102 may be composed of multiple video divisions 202. Each video division 202 may be divisions of the video, such as pixels. Video divisions 202 may be grouped into blocks. For example, video divisions 202 may be grouped into 8 video divisions by 8 video divisions block 204.

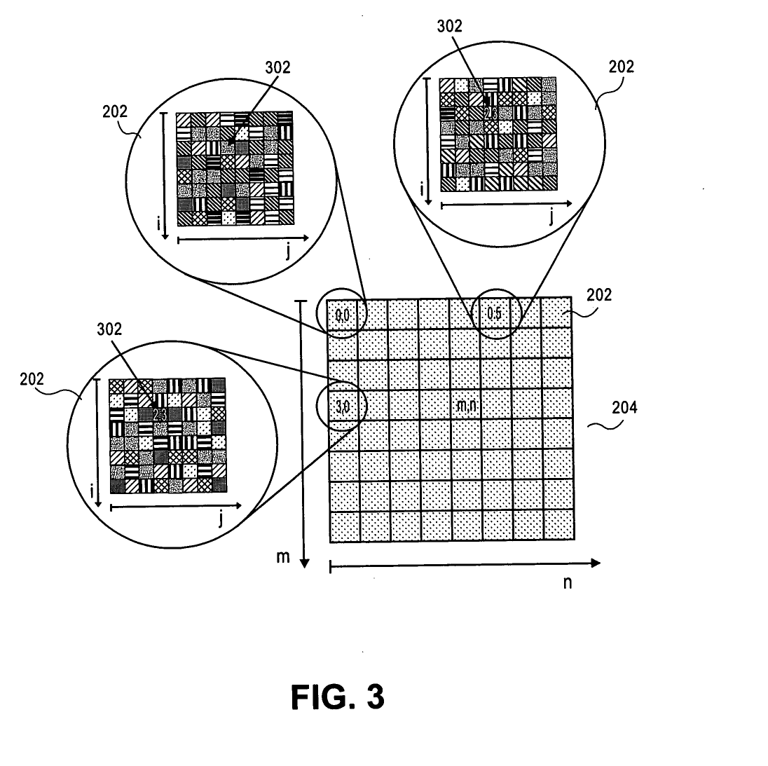

To properly display video using the transformation coefficients K(i,j), each division 202 of display unit 102 may be further divided into sub-divisions, such as sub-pixels. FIG. 3 is a diagram illustrating exemplary sub-divisions of video divisions 202 in an 8×8 block 204 of video divisions 202. As illustrated in FIG. 3, each video division 202 may represent a pixel m,n in display 102. Each video division 202 may be divided into sub-divisions 302. Each sub-division 302 may represent physical divisions of display unit 102. For example, if display unit 102 includes an LCD panel and light source, sub-divisions 302 may represent the physical LC cells or light source divisions of display unit 102

The number of the sub-divisions 302 may be equal to the number of transformation coefficients or partial coefficients, for example JPEG coefficients K(i,j). For example, as illustrated in FIG. 3, a particular video division 202 may be sub-divided into 64 sub-divisions 302. One skilled in the art will realize that the number of divisions is exemplary and that display unit 102 may be divided into any number of divisions and sub-divisions as required by the compression method.

Display 100 produces actual viewable video by driving display unit 102 with a video signal corresponding to transform coefficients K(i,j). Each sub-division 302 of display unit 102 is driven with the corresponding transform coefficient K(i,j). Then, each sub-division 302 may transform the corresponding video into actual viewable video. To achieve this, sub-divisions 302 have a gain related to the corresponding inverse transformation coefficient of the transformation algorithm. The gain for each sub-division may be achieved by using any hardware, software, firmware, or combination thereof to increase or reduce the video signal. For example, if the JPEG compression algorithm is utilized, the gain may be given as follows:

$$C ( i ) C ( j ) Q ( i , j ) cos \frac{( 2 m + 1 ) i π}{16} cos \frac{( 2 n + 1 ) j π}{16} .$$

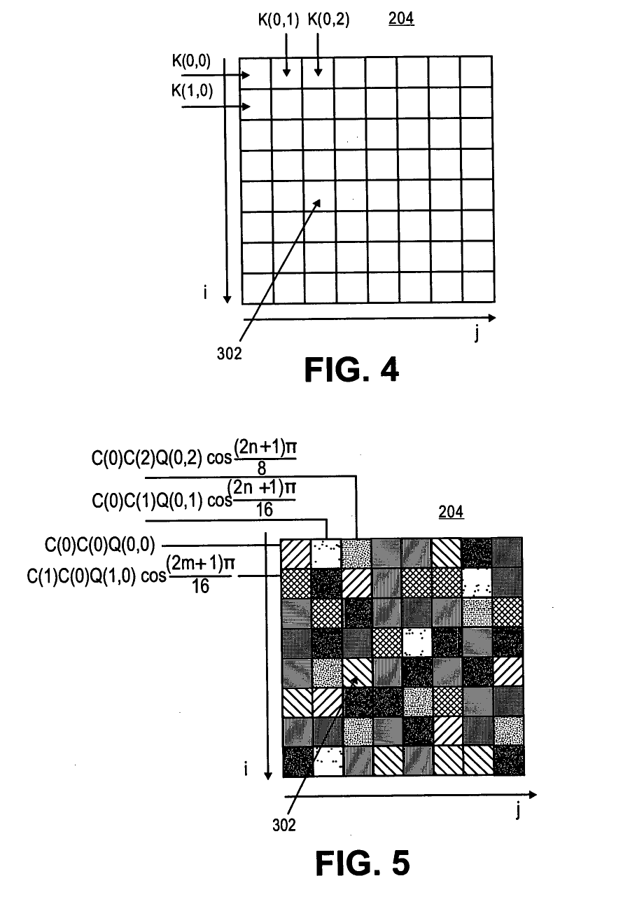

FIGS. 4 and 5 are diagrams illustrating the transform coefficients supplied to display unit 102 and the gain of the sub-divisions of display unit 102 for a particular pixel m,n. As illustrated in FIG. 4, sub-divisions 302 may be supplied with different transformation coefficients. For example, the transform coefficients may be supplied to display unit 102, for example, as follows:

Sub-division 0,0-K(0,0);

Sub-division 1,0-K(1,0);

Sub-division 0,1-K(0,1); and

Sub-division 0,2-K(0,2)

As such, the corresponding sub-division 302 may have a gain related to the inverse transform coefficients in order to transform the video signal received by sub-divisions 302 into actual viewable video. For example, as illustrated in FIG. 5, sub-division 302 corresponding to K(0,0) may have a gain proportional to

C(0)C(0)Q(0,0).

Sub-division 302 corresponding to K(1,0) may have a gain proportional to

$$C ( 1 ) C ( 0 ) Q ( 1 , 0 ) cos \frac{( 2 m + 1 ) π}{16} .$$

Sub-division 302 corresponding to K(0,1) may have a gain proportional to

$$C ( 0 ) C ( 1 ) Q ( 0 , 1 ) cos \frac{( 2 n + 1 ) π}{16} .$$

Sub-division 302 corresponding to K(0,2) may have a gain proportional to

$$C ( 0 ) C ( 2 ) Q ( 0 , 2 ) cos \frac{( 2 n + 1 ) π}{8} .$$

where m,n is the position of the division in the 8×8 block. Accordingly, the video output by display 100 after processing by display unit 102 would appear as actual viewable video.

One skilled in the art will also realize that any transformation or compression/decompression algorithm may be utilized to determine the number of sub-divisions of video division 202 and the gains of display unit 106. For example, the number of sub-divisions of video divisions 202 and the gains of display unit 102 may be related to transformation values in the MPEG algorithm.

FIGS. 2-5 illustrate 64 K(i,j) sub-divisions for each division (or individual filter). Display unit 102 may be divided into less sub-divisions such as 20. One skilled in the art will realize that display unit 102 may be divided into any number of sub-divisions depending on the desired number of transform coefficients or partial coefficients.

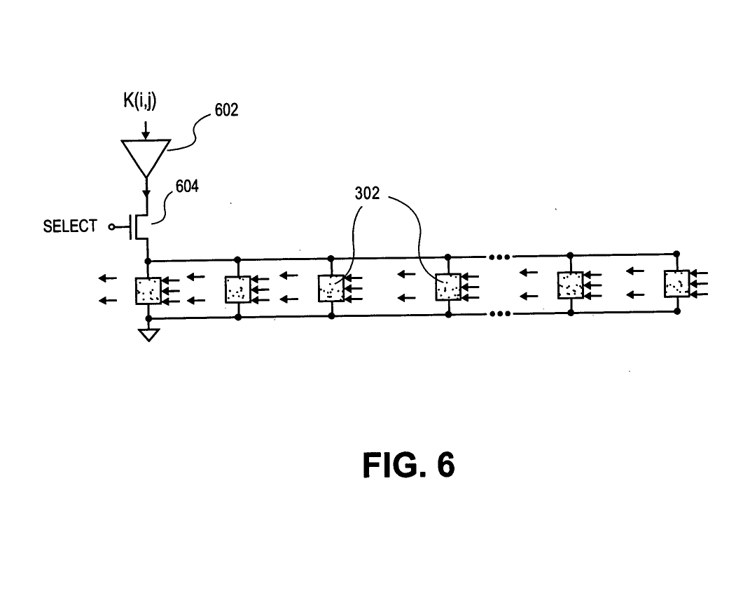

Since the video signal supplied to each corresponding sub-division in different divisions of a common 8×8 block of display unit 102 represent the same transform coefficient or partial coefficient, all the sub-divisions having the same transform coefficient or partial coefficient may be connected in parallel in order to receive the same signal. FIG. 6 is a schematic diagram illustrating a driving circuit 600 for supplying a video signal to sub-divisions 302, for example sub-pixels, in different divisions, for example pixels m,n in a common 8×8 block. For example, driving circuit 600 may be utilized to supply K(0,1) to all sub-divisions 0,1 in pixels m,n in an 8×8 block. Sub-divisions 302 may be, for example, the individual LC cells if a LC panel is utilized. Driving circuit 600 may be included in display control 104.

It should be readily apparent to those of ordinary skill in the art that driving circuit 600 illustrated in FIG. 6 represents a generalized schematic illustration and that other components may be added or existing components may be removed or modified. Further, one skilled in the art will realize that display device 100 would have a driving circuit 600 for each different transform coefficient K(i,j).

As illustrated in FIG. 6, driving circuit 600 comprises an amplifier 602 and a transistor 604 coupled to amplifier 602. Amplifier 602 amplifies the signal supplied, which corresponds to K(i,j), to sub-divisions 302 of display unit 102. Transistor 604 controls when the video signal, which corresponds to K(i,j), is supplied to sub-divisions 302 of display 102.

As illustrated in FIG. 6, transistor 604 is coupled in parallel to each sub-divisions i,j for different divisions m,n. For example, for sub-division 0,1, transistor 604 may be coupled to each sub-division 0,1 in all divisions 202 of an 8×8 block.

Amplifier 602 and transistor 604 may be utilized to provide gain to the video signal in order to produce actual video. One skilled in the art will realize that additional hardware may be included to provide gain to each individual sub-division 302 in order to produce actual video.

As mentioned above, display 100 includes display unit which converts the video signal representing transformation values into the actual viewable video. According to other embodiments of the invention, the gain of each sub-division as mention above may be achieved by varying the areas of sub-divisions in display unit 102 of display 100. The sub-division areas may be related to a coefficient or partial coefficient in a transformation algorithm.

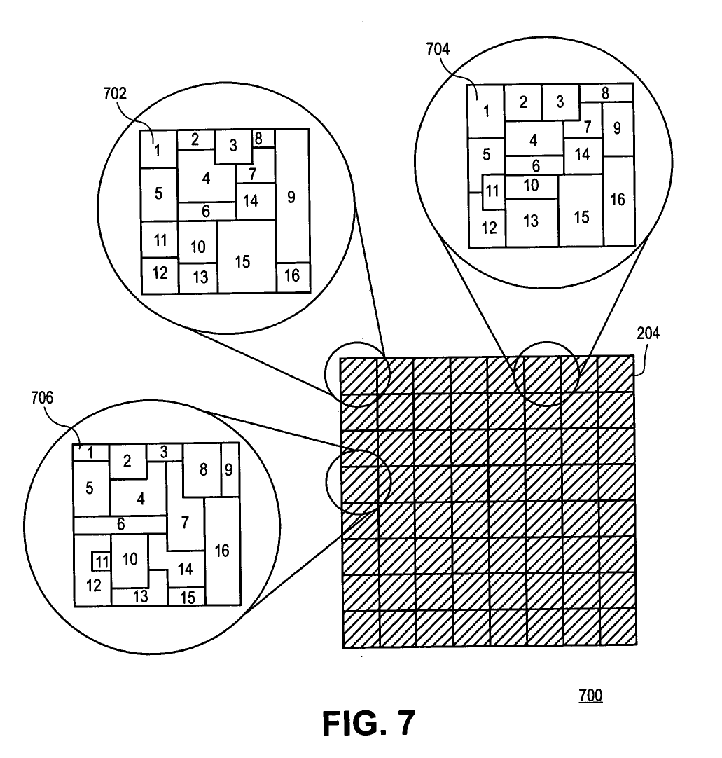

FIG. 7 is a diagram of an exemplary 8×8 block 700 of video division 202 of display unit 102 consistent with embodiments of the present teachings. It should be readily apparent to those of ordinary skill in the art that FIG. 7 is exemplary and that other components may be added or existing components may be removed or modified.

As illustrated in FIG. 7, each video division 202 in display unit 102 comprises a set of sub-division, such as sub-divisions 702, 704, and 706, having various areas. As shown in FIG. 7, each sub-division may have an area depending on its location in division 202. Further, each sub-division may have an area depending on which division 204 it is located.

As illustrated in FIG. 7, the sub-division areas may be related to a transform coefficient or partial coefficient in a transformation algorithm. For example, the sub-division areas may be related to transformation coefficients or partial coefficients in the JPEG decompression algorithm. As illustrated in FIG. 7, each sub-division may have a different physical size depending on it location.

For example, a particular sub-division may require a gain which increases the intensity by 50% based on the transformation coefficient or partial coefficient driving the sub-division. To achieve gain, the sub-division's area may be increased by appropriate amount to achieve the 50% intensity increase. In general, the sub-division (i,j) of video division (m,n) for a certain JPEG 8×8 block will have an area proportional to:

$$C ( i ) C ( j ) Q ( i , j ) cos \frac{( 2 m + 1 ) i π}{16} cos \frac{( 2 n + 1 ) j π}{16} .$$

By having varying sub-division areas, display 100 may still display a compressed video signal.

Since the same position sub-division of different video division of display unit 102 represent a transformation coefficient or partial coefficient, all the corresponding sub-divisions for all video division in an 8×8 block may be driven by the same signal. A driving circuit, such as driving circuit 600, may be used to drive the sub-divisions.

While the invention has been described with reference to the exemplary embodiments thereof, those skilled in the art will be able to make various modifications to the described embodiments without departing from the true spirit and scope. The terms and descriptions used herein are set forth by way of illustration only and are not meant as limitations. In particular, although the method has been described by examples, the steps of the method may be performed in a different order than illustrated or simultaneously. Those skilled in the art will recognize that these and other variations are possible within the spirit and scope as defined in the following claims and their equivalents.

What is claimed is:

1. A display configured to display transformed video, the display comprising:
a display unit comprising pixels, wherein each pixel is divided into sub-divisions and each sub-division has a gain that is related to coefficients or partial coefficients in a transformation algorithm.

2. The display of claim 1, wherein the pixels are arranged in pixel blocks.

3. The display of claim 2, further comprising:
driving circuits coupled to corresponding sub-divisions of different pixels in the display unit.

4. The display of claim 4, wherein the driving circuits provide a signal representing transformed video to the corresponding sub-divisions.

5. The display of claim 2, wherein the pixel blocks comprise a block of 8 pixels by 8 pixels.

6. The display of claim 1, wherein each pixel of the display unit comprises 8 sub-divisions by 8 sub-divisions.

7. The display of claim 1, wherein each pixel of the display unit comprises less than 8 sub-divisions by 8 sub-divisions.

8. The display of claim 1, wherein corresponding sub-divisions of pixels have areas related to a coefficient or partial coefficient of an image transform.

9. The display of claim 8, wherein the coefficients or partial coefficients are terms of product terms in sub-terms of a product transform.

10. The display of claim 9, wherein a sum of product transforms is defined by the JPEG compression algorithm.

11. The display of claim 1, wherein each sub-division has an area that is related to coefficients or partial coefficients in a transformation algorithm.

12. A display configured to display transformed video, the display comprising:
a display unit comprising video divisions groped into blocks, wherein each video division is divided into sub-divisions and each sub-division has a gain that is related to coefficients or partial coefficients in a transformation algorithm.

13. The display of claim 12, further comprising:
a set of driving circuits coupled to the display unit, wherein each driving circuit is coupled to corresponding sub-divisions of different video divisions in a block.

14. The display of claim 12, wherein the blocks comprise a block of 8 video divisions by 8 video divisions.

15. The display of claim 12, wherein each video division of the display unit comprises 8 sub-divisions by 8 sub-divisions.

16. The display of claim 12, wherein each video division of the display unit comprises less than 8 sub-divisions by 8 sub-divisions.

17. The display of claim 12, wherein corresponding sub-divisions of video divisions have areas related to a coefficient or partial coefficient of an image transform.

18. The display of claim 17, wherein the coefficients or partial coefficients are terms of product terms in sub-terms of a product transform.

19. The display of claim 12, wherein each sub-division has an area that is related to coefficients or partial coefficients in a transformation algorithm.

20. A device, comprising:
a video source capable of providing a compressed video signal representing transformation values of a compression method; and
a display configured to display the compressed video signal based on the transformation values, the display comprising:
a display unit comprising pixels, wherein each pixel is divided into sub-divisions and each sub-division has an area that is related to coefficients or partial coefficients in a transformation algorithm.
